(19) United States
(12) Patent Application Publication
(10) Pub. No.: US 2020/0286240 A1
(43) Pub. Date: Sep. 10, 2020

(54) METHOD OF SEGMENTING A 3D OBJECT IN A MEDICAL RADIATION IMAGE

(71) Applicant: Agfa HealthCare NV, Mortsel (BE)

(72) Inventors: Asma OUJI, Mortsel (BE); Yoni DE WITTE, Mortsel (BE)

(21) Appl. No.: 16/761,272

(22) PCT Filed: Nov. 9, 2018
(86) PCT No.: PCT/EP2018/080725

§ 371 Date: May 4, 2020

(30) Foreign Application Priority Data
Nov. 9, 2017 (EP) 17200804.7

(51) Int. Cl. G06T 7/174; G06T 7/00

(52) U.S. Cl. CPC G06T 7/174; G06T 7/0012; G06T 2207/10072; G06T 2207/30004; G06T 2207/20104

(57) ABSTRACT

Based on user input, a set of contour points of a 3D object is defined in a number of 2D slice images representing the 3D object. A 2D distance map is computed in each plane where a contour is defined. Next, a 3D distance map is created via a linear interpolation of the 2D distance maps. Each voxel is classified as in/out the segmentation mask depending on its corresponding distance map value.

### CROSS REFERENCE TO RELATED APPLICATIONS

This application is a 371 National Stage Application of PCT/EP2018/080725, filed Nov. 9, 2018. This application claims the benefit of European Application No. 17200804.7, filed Nov. 9, 2017, which is incorporated by reference herein in its entirety.

### BACKGROUND OF THE INVENTION

### 1. Field of the Invention

The present invention relates to a method of segmenting a 3D object in a medical radiation image such as a Computed Tomography (CT) or a Magnetic Resonance image.

Typical objects that need to be segmented in an image are multi-tissue organs (e.g. kidney, liver) and low contrasted tumors (e.g. brain tumor, liver tumor, etc.).

The invention is valuable for diagnosis, medical assessment and follow up. It is indeed important to segment a tumor or an organ to measure its size and compare it with previous measurements over time. It is also important to segment such objects to better visualize and analyse their shape and morphological aspects.

### 2. Description of the Related Art

Methods for segmenting objects in 3D images are known in the art.

A number of segmentation tools based on intensity values (which reflects the type of the corresponding tissue) have been described such as the region grower described in Agfa HealthCare's European patent application EP 3063735 published Sep. 7, 2016. Most of these tools are dedicated to specific organs or tumors, for example unpublished European patent application 16203673.5 filed Dec. 13, 2016.

However, because of large variety in intensity values (due to a mixture in tissue composition), some organs (e.g. the kidney, the heart, etc.) cannot be segmented by classical intensity based algorithms. Such algorithms are also unable to segment tumors/lesions with very low contrast properly. For all these reasons, we propose a segmentation algorithm which is purely geometrical, not using any voxel intensity assumption.

Few interpolation algorithms exist in the literature, e.g. in U.S. Pat. No. 8,571,277 and in the publication IEEE Trans Med Imaging, 1996, 15(6): 881-92, Shape-based interpolation of multi-dimensional grey-level images, Grevera GJ, Udupa JK, interpolation methods have been described. The described methods use pixel intensity values and take full surfaces as user input.

It is an aspect of the present invention to provide an enhanced method for segmenting a 3D object in a medical radiation image that overcomes the above-mentioned disadvantages.

### SUMMARY OF THE INVENTION

The above-mentioned aspects are realised by a method having the specific steps set out below.

Specific features for preferred embodiments of the invention are also set out below.

Further advantages and embodiments of the present invention will become apparent from the following description and drawings.

With the input of few 2D contours defining the region to be segmented in 2D images, a 3D mask is created via geometrical linear interpolations of contour distance maps defined in the 2D slice images.

The algorithm is not texture dependent since it is purely geometrical so it can segment any type of region and it handles bifurcations properly. It is also fast so it can be used to segment big organs such as the liver.

As input, our algorithm requires a set of contours, typically 2 or 3 (or more for complex shapes), each defined in one plane. A plane may be a slice of a tomographic representation of an object or it may be a modified slice, e.g. a rotated slice or any other 2D image representation.

These contours are drawn by the user around the region to be segmented in a few planes, at least two planes being required (e.g. in FIG. 1a). Contour points of the area to be segmented or a definition of the area defining the region to be segmented can be determined in other ways.

As output, the algorithm creates a 3D segmentation mask by interpolating the contour points (e.g. in FIG. 1b).

This algorithm is designed to interpolate contours defined in parallel planes, but it can also handle non-parallel contours. However, the interpolation results are much more accurate on parallel planes.

The full process can be summarized by the following steps:
1) The user draws a few contours, preferably in parallel planes of the radiation image representation (in 2D slices)
2) A 3D segmentation mask is computed as follows:
   a. A 2D distance map is computed in each plane where a contour is defined,
   b. A 3D distance map is created via a linear interpolation of the 2D distance maps,
   c. Each voxel is classified as in/out the segmentation mask depending on its corresponding distance map value.

The present invention is generally implemented in the form of a computer program product adapted to carry out the method steps of the present invention when run on a computer combined with user interaction to define the initial contours in the image planes.

The computer program product is commonly stored in a computer readable carrier medium such as a DVD. Alternatively the computer program product takes the form of an electric signal and can be communicated to a user through electronic communication.

### BRIEF DESCRIPTION OF THE DRAWINGS

FIG. 1 illustrates the interpolation of 3 parallel contours defining a kidney.

FIG. 2 is a slice image of the interpolated mask of FIG. 1.

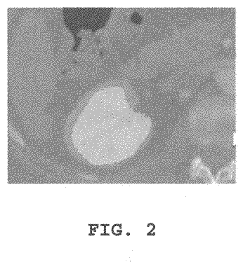

FIG. 3 illustrates the interpolation of contours defining a bifurcation.

FIG. 4 is an example of a 2D distance map computed on a plane containing one contour.

FIG. 5 is a bounding box of two parallel contours.

FIG. 6 is an illustration of the 3D distance map interpolation.

### DETAILED DESCRIPTION OF THE PREFERRED EMBODIMENTS

Radiation images of 3D objects are typically generated by applying image recording techniques such as Computer Tomography or Magnetic Resonance Imaging.

The medical image representation generated by these techniques consists of a number of 2D slice images (also called ‘planes’) obtained by scanning the object.

In CT imaging the slice images are generated by exposing the object and recording images from different angles so as to produce cross-sectional (tomographic) images (virtual “slices”) of specific areas of a scanned object.

In MR imaging the results form an exposure are also slice images.

The radiation used for imaging can thus be of different types such as x-rays, radio waves etc.

The invention is generally applicable to 3D imaging techniques that produce slice images or image planes. The input to the method of the present invention is a set of slice images, at least two, of a 3D image representation of an object.

The slice images may be original slice images but likewise it may be modified slice images, e.g. rotated slice images.

Typically these slice images not only comprise the object but also include pixels surrounding the object. A segmentation process to separate the object from the remainder of the image is desired for some applications such as diagnosis, medical assessment and follow up.

In order to execute the segmentation method of the present invention, the user performs a first and single action on the display of a number of slice images out of the acquired image representation of the 3D image. This step is the only interactive one (the only step which requires user interaction). The results of the user action are fed into an image processing device that runs a software implementation of the method of the present invention as explained further on.

In a first step, the slice images that will be taken into account are displayed on a monitor. At least two slice images are required to be able to perform the method of the present invention.

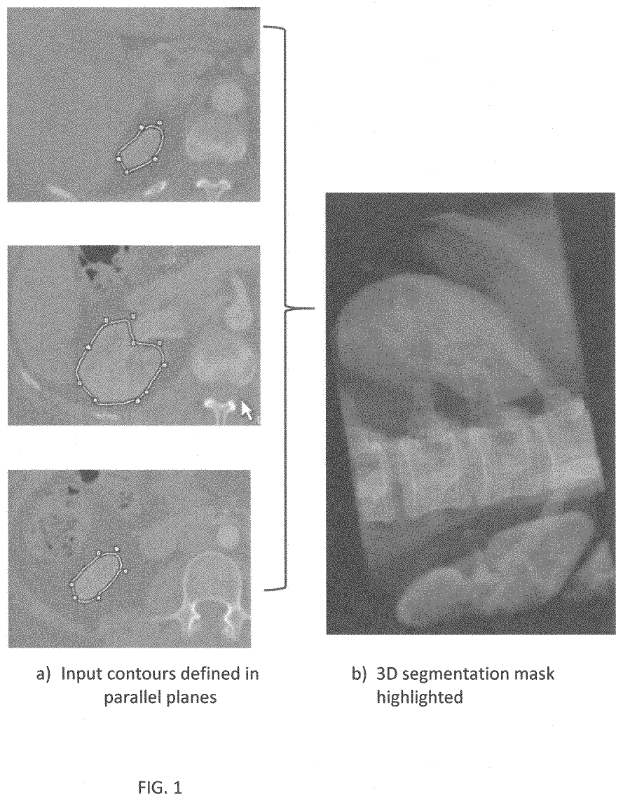

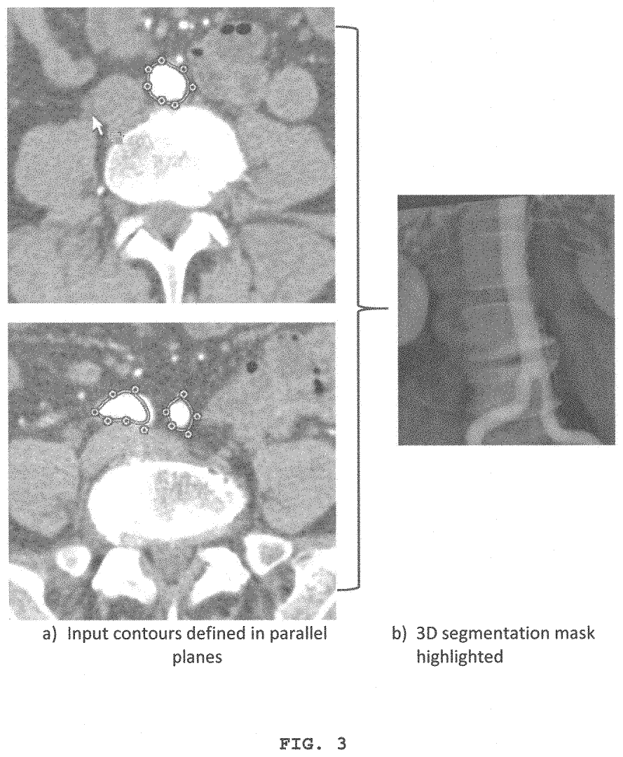

The user draws few contours (FIG. 1a and FIG. 3a) around the object (tumor, organ, etc.) to be segmented. The contours are drawn on the displayed 2D images (planes). These planes can have any space direction but they should be preferably parallel.

The segmentation mask is computed inside the region defined by the bounding box of all contours. A bounding box in the context of this invention is a volume that contains all defined contours. Preferably this is the smallest bounding box containing all contours. Larger bounding boxes can be used, however all voxels outside the smallest bounding box would fall outside the segmentation mask.

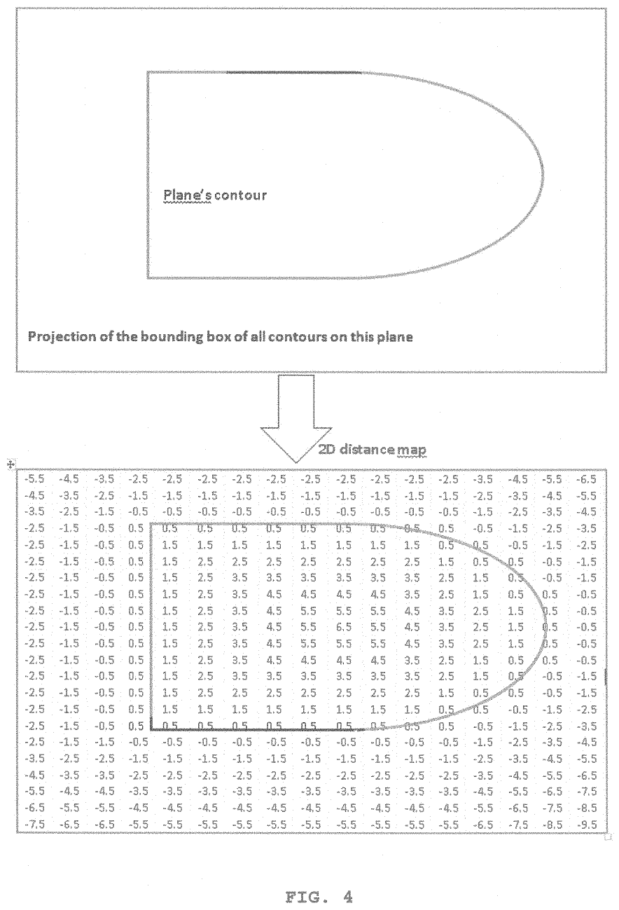

For each plane containing a contour, a 2D distance map is computed in the region limited by the projection of the bounding box on this plane. This distance map is defined such as all points inside a plane's contour are positive and all remaining points are negative. The absolute value of the 2D distance map at a given point is linearly dependent on its distance to the closest contour point; i.e. for each point in the plane, the distance map absolute value gets bigger as its distance from the closest contour (defined in the same plane) is bigger. FIG. 4 illustrates the distance map computation algorithm.

Given all 2D distance maps computed on the labelled planes, a 3D distance map is interpolated as explained below.

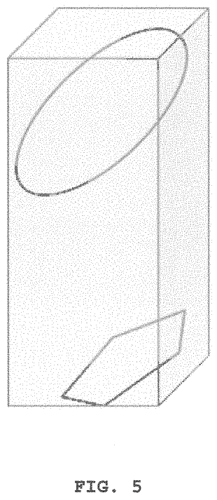

The 3D distance map is defined in the region delimited by the bounding box containing all contours (example of bounding box in FIG. 5).

For each voxel inside this region and not already labeled (i.e. not belonging a plane where a 2D distance map is defined), the two closest planes are fetched. These two planes must surround (be located in opposite sides towards the voxel) the voxel if they are parallel.

Let d1 be the distance of the voxel to the first closest plane and d2 its distance to the second one. Total is the sum of d1 and d2.

The voxel is projected on the two planes respectively. Let cost 1 and cost 2 be the 2D distance map value of the projection point on the first and second planes respectively.

The interpolated distance map value is: cost 1×(1−d1/total)+cost 2×(1−d2/total).

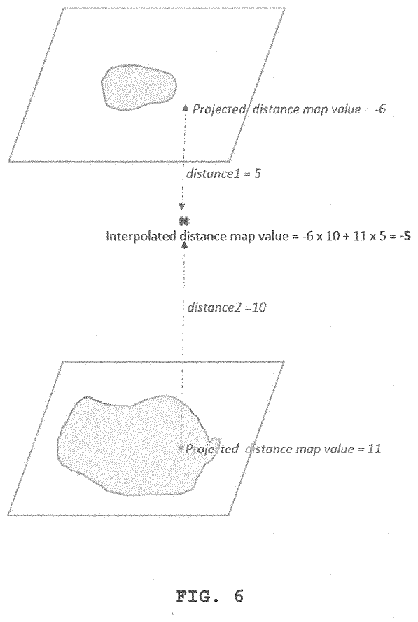

An illustration of the distance map interpolation on one sample voxel is presented in FIG. 6.

Once the distance map is computed for all voxels within the bounding box, the final segmentation mask is obtained by thresholding this distance map: all voxels with a positive distance map value belong the interpolation mask, and all others are outside of it.

Once the segmentation map is obtained, voxels classified as being in or out the segmented area can be used for further processing, analysis, display etc.

1-4. (canceled)

5. A method of segmenting a 3D object in a radiation image represented by 2D slice images, the method comprising:
displaying at least two of the 2D slice images;
for the displayed 2D slice images, defining a contour as a set of contour points around the 3D object to be segmented;
computing a 2D distance map in each of the 2D slice images where the contour is defined, values of the 2D distance map representing a distance of a pixel to the contour defined in the 2D slice image;
defining a region delimited by a bounding box containing all of the contours;
for each voxel in the region delimited by the bounding box that does not belong to a plane for which the 2D distance map is defined, the voxel being denoted as unlabeled, fetching two 2D slice images among the 2D slice images at a smallest distance from the voxel and on opposite sides of the voxel;
calculating an interpolation mask as an interpolated 3D distance map for each unlabeled voxel from corresponding values for the voxel in the 2D distance maps; and
thresholding the interpolated 3D distance map so that the voxels belonging to the interpolation mask have a first distance map value when and all others of the voxels have a second distance map value and are outside the interpolated 3D distance map.

6. The method according to claim 5, wherein the planes of the 2D slice images are parallel, and two closest 2D slice images are located on opposite sides of the voxel for which an interpolated value is calculated.

7. The method according to claim 6, wherein values of the interpolated 3D distance map are calculated according to the formula:
cost 1×(1−d1/total)+cost 2×(1−d2/total)
wherein
d1 is a distance of one of the voxels to a first 2D slice image;
d2 is a distance of the one of the voxels to a second 2D slice image;
total is a sum of d1 and d2; and
cost 1 and cost 2 are 2D distance map values of a projection point of the one of the voxels in each of the first and second 2D slice images.

8. The method according to claim 5, wherein the radiation image is a medical image.
